(19) United States
(12) Patent Application Publication
(10) Pub. No.: US 2020/0198716 A1
(43) Pub. Date: Jun. 25, 2020

(54) COLLAPSIBLE ARTICLE CARRIER FOR TRANSPORTATION DEVICES

(71) Applicant: Anchor Product Design, LLC dba Parallel, Stoneham, MA (US)

(72) Inventor: Joshua Gomes, Cambridge, MA (US)

(73) Assignee: Anchor Product Design dba Parallel, Stoneham, MA (US)

(21) Appl. No.: 16/226,615

(22) Filed: Dec. 19, 2018

(51) Int. Cl. B62J 9/00

(52) U.S. Cl. CPC B62J 9/005; B62J 7/02

(57) ABSTRACT

An article carrier for bicycles can include a bag that can have first and said opposing walls. The article carrier can further include at least two coupling elements that can be mechanically coupled to the first wall and at least two coupling elements that can be mechanically coupled to the second wall. Each of the coupling elements mechanically coupled to the first wall can each be configured removably couple to at least one coupling element mechanically coupled to the first wall. The article carrier can also include a pouch coupled to the bag. The pouch can be configured to store at least the bag, the at least two coupling elements coupled to the first wall, and the at least two coupling elements coupled to the second wall.

### CROSS REFERENCE

Not applicable.

### STATEMENT REGARDING FEDERALLY SPONSORED RESEARCH

Not applicable.

### FIELD

This disclosure relates generally to article carriers for use with transportation devices and, more particularly, to removable article carriers configured to collapse into a pouch.

### BACKGROUND

In the field of transportation devices, article carriers are used to transport various articles and loads while the device is in motion. Typically, these article carriers attach to the front or rear of the transportation device adding extra weight and interfering with the aerodynamics of the transportation device. Although some article carriers are configured to be removeable from the transportation device, the process for removing the article carrier may be time consuming and cumbersome. Further, once these article carriers have been removed from the transportation device, they are difficult to store when not in use.

To reduce the weight added to the transportation device, some article carriers have been built using lightweight materials. However, these designs can lack the rigidity required to prevent the article carrier from tearing when carrying a load. These designs can also lack water resistance or water-proofing that may lead to water damage for any articles carried by the article carriers.

### SUMMARY

According to the disclosure, an article carrier for bicycles can include a bag that can have first and said opposing walls. The article carrier can further include at least two coupling elements that can be mechanically coupled to the first wall and at least two coupling elements that can be mechanically coupled to the second wall. Each of the coupling elements mechanically coupled to the second wall can each be configured removably couple to at least one coupling element mechanically coupled to the first wall. The article carrier can also include a pouch coupled to the bag. The pouch can be configured to store at least the bag, the at least two coupling elements coupled to the first wall, and the at least two coupling elements coupled to the second wall.

With this arrangement, a removably couplable article carrier that can be stored when not in use is achieved. Because each coupling element is configured to be removably coupled to a respective coupling element, the article carrier can be quickly coupled or uncoupled from the bicycle. Further, when the article carrier is not in use, it can be stored in the pouch, allowing for easy storage of the article carrier.

Features may include one or more of the following individually or in combination with other features. In embodiments the at least two coupling elements mechanically coupled to the first wall and the at least two coupling elements mechanically coupled to the second wall can be configured to couple the bag to two or more portions of the bicycle when each of the coupling elements mechanically coupled to the first wall are removably coupled to respective coupling elements mechanically coupled to the second wall. In embodiments, a force can be applied to the bag when the bag is coupled to the two or more portions of the bicycle. The bag can have a shape based upon the applied force. In embodiments, the shape of the bag can be further based upon a distance between the first and second portions of the bicycle.

In embodiments, the first wall of the bag can include an anchor point. The anchor point can be mechanically coupled to at least one coupling element mechanically coupled to the first wall.

In embodiments, the bag can also have a zipper configured to adjust a size of an opening of the bag.

In embodiments, the pouch can be configured to store the bag, the at least two coupling elements coupled to the first wall, and the at least two coupling elements coupling to the second wall.

Also described is an article carrier that can be configured to be removably coupled to a bicycle. The article carrier can include a bag and at least four coupling elements. At least two of said coupling elements can have a first gender and at least another two of said coupling elements can have a second gender. The at least two coupling elements having the first gender can be configured to be removably coupled with the at least two coupling elements having the second gender. The article carrier can further include a pouch. The pouch can be configured to store at least the bag, the coupling elements of the first gender, and the coupling elements of the second gender. The pouch can also include a coupling cord. The coupling cord can be configured to couple the pouch to the bicycle when the bag, the coupling elements of the first gender, and the coupling elements of the second gender are stored in the pouch.

With this arrangement, an easily-storable article carrier is achieved. By storing the bag and coupling elements in the pouch, the article carrier can be reduced in size when not in use. Further, because the pouch can be coupled to the bicycle, the stored article carrier does not need to be carried by the operator of the bicycle.

Features may include one or more of the following individually or in combination with other features. In embodiments, the pouch can include a cord that can be configured to adjust an opening of the pouch.

In embodiments, the coupling cord can be configured to apply a force to the pouch and the bicycle when the pouch is coupled to the bicycle. The pouch can also include a hook that may be configured to adjust the force applied to the pouch and the bicycle when the pouch is coupled to the bicycle. In embodiments, the pouch can have a volume less than 25 cubic inches.

In embodiments, the bag can also include an anchor point coupled to one or more coupling elements of the first gender. In embodiments, the at least four coupling elements can be configured to removably couple the article carrier to the bicycle when the at least two coupling elements of the first gender are removably coupled with the at least two coupling elements of the second gender.

Also described is an article carrier for a transportation device that can include a bag. The bag can include first and second opposing walls, each of said walls can include an anchor point. The article carrier can also include a first coupling element that can be mechanically coupled to the anchor point of the first wall and a second coupling element that can be mechanically coupled to the anchor point of said second wall. The second coupling element can be configured to removably couple to the first coupling element. The article carrier may also include a pouch that can be coupled to the bag. The pouch can be configured to store at least the bag, the first coupling element, and the second coupling element.

Features may include one or more of the following individually or in combination with other features. In embodiments, the first and second coupling elements can be configured to removably couple the article carrier to the transportation device when the first and second coupling elements are coupled together. In embodiments, the anchor point of the first wall can include a material coupled to at least a portion of the first wall.

In embodiments, the material of the anchor point can include the same material as the first wall. In embodiments, the anchor point can include a material having a thickness greater than a material of the first wall.

In embodiments, the anchor point can be coupled to at least a portion of the first wall with a lockstitch pattern.

### BRIEF DESCRIPTION OF THE DRAWINGS

The concepts, structures, and techniques sought to be protected herein may be more fully understood from the following detailed description of the drawings, in which:

FIG. 1 is an orthogonal view of an article carrier configured to couple to a transportation device, according to some embodiments;

FIG. 2 is an orthogonal view of a pouch coupled to an article carrier, according to some embodiments;

FIG. 3A is an orthogonal view of an article carrier coupled to a bicycle, according to some embodiments;

FIG. 3B is a front view of an article carrier coupled to a bicycle, according to some embodiments;

FIG. 3C is an interior view of a wall of an article carrier, according to some embodiments;

FIG. 4A is a front view of a portion of an article carrier demonstrating a coupling pair, according to some embodiments;

FIG. 4B is a rear view of a portion of an article carrier demonstrating a coupling pair, according to some embodiments;

FIG. 5A is a top-down view of an article carrier, according to some embodiments;

FIG. 5B is a top-down view of an article carrier carrying articles, according to some embodiments;

FIG. 6 is an orthogonal view of a pouch coupled to a bicycle, according to some embodiments;

The drawings are not necessarily to scale, or inclusive of all elements of a system, emphasis instead generally being placed upon illustrating the concepts, structures, and techniques sought to be protected herein.

### DETAILED DESCRIPTION

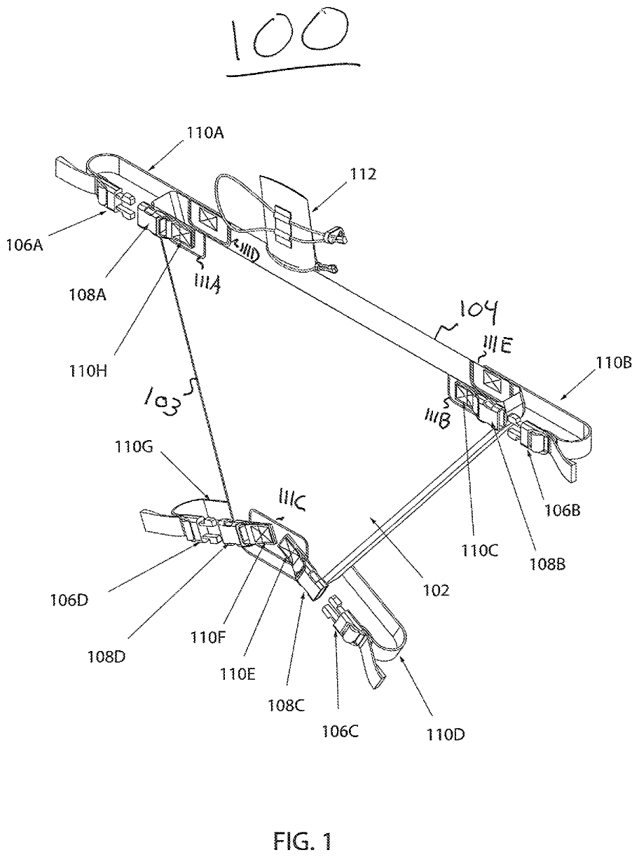

Referring now FIG. 1, article carrier 100 is configured to carry a load of one or more articles and includes at least first wall 102 and a second, opposite wall 104. Each of said walls has opposing surfaces and a predetermined thickness. The surfaces of each wall 102, 104 can have a shape comprising at least three sides, in other words, the surfaces of each wall 102, 104 can have a shape comprising a triangle, a parallelogram (e.g. a rectangle, a square, a trapezoid, etc.), a pentagon, etc.

In embodiments, the surfaces of walls 102, 104 can have substantially similar shapes so that walls 102, 104 may be mechanically coupled to form bag 103. For example, the surfaces of each wall can have a trapezoidal shape with substantially similar dimensions so that the walls can be mechanically coupled to form bag 103. The walls 102, 104 can be mechanically coupled together via stitching, fusing, adhesive, or any combination thereof. According to embodiments, bag 103 comprises a bag configured to carry a load of one or more articles.

As can be seen from the illustrated article carrier 100 in FIG. 1, when walls 102, 104 are coupled together to form bag 103, each wall 102, 104 has a surface that forms at least a portion of an exterior of bag 103 (referred to herein as an external surface) and a surface that forms at least a portion of the interior of bag 103 (referred to herein as an internal surface).

In embodiments, walls 102, 104 are stitched together to form a bag 103. Walls 102, 104 may be stitched together in a general seam, felled seam, taped seam, or any combination thereof—to name a few. The stitching between walls 102, 104 can comprise polyester thread, nylon thread, cotton thread, or any combination thereof—to name a few. One of ordinary skill will appreciate that a desired stich pattern and stitch material can be chosen according to desired parameters (e.g. carry load, flexibility, water-proofing, etc.) for bag 103.

Each wall 102, 104 can comprise a material such as rip-stop polyester, rip-stop nylon, polyester, vinyl, nylon, rubber, cotton, leather, polypropylene, or any combination thereof, to name a few. One of skill in the art will appreciate that materials for each wall 102, 104 may be chosen to achieve a desired weight, rigidity, water resistance, flexibility, and carry load of bag 103.

According to embodiments, bag 103 may be configured to collapse, or fold when not carrying a load. That is to say, the size of bag 103 is configured to diminish when bag 103 is not carrying a load. For example, a material may be selected for walls 102, 104 so that bag 103 collapses in size when it is not carrying a load.

In embodiments, walls 102, 104 may be coated in a water-resistant material so that the bag 103 is water-resistant or water proof. The water-resistant material can comprise wax, silicon oil, resin, polyurethane, epoxy, fluoropolymer resins (e.g. polytetrafluoroethylene, fluorinated ethylene propylene, perfluoroalkoxy copolymer etc.), or any combination thereof—to name a few examples. In embodiments, walls 102, 104 may be also coupled so that the formed bag is water-resistant or waterproof. One of ordinary skill in the art will appreciate that a water-resistant or waterproof bag can be achieved by selecting an appropriate coupling between walls 102, 104 and an appropriate material or coating for each wall 102, 104.

In an example embodiment, each wall 102, 104 can comprise rip-stop nylon coated in a water-resistant material thus allowing for a light-weight, strong, water-resistant, flexible bag to be formed from the walls 102, 104.

According to embodiments, article carrier 100 may be configured to be removably coupled to a transportation device (e.g. a bicycle) via coupling elements 106, 108. Each wall 102, 104 is respectively mechanically coupled to at least two coupling elements 108, 110. For example, in the illustrated embodiment of FIG. 1, wall 102 is mechanically coupled to coupling elements 108A-D and wall 104 is mechanically coupled to coupling elements 106A-D. In embodiments, each coupling element 106, 108 can comprise buckles, hooks, Velcro, latches, or any combination thereof—to name a few examples.

In embodiments, at least two coupling elements 106, 108 can be coupled to a wall 102, 104 at points disposed around two or more sides of the wall 102, 104. In some embodiments, the coupling elements, 106, 108 can be coupled to a wall 102, 104 at points disposed around all but one side of the wall 102, 104 while in other embodiments the coupling elements 106, 108 can be coupled to points disposed around a fewer number of sides. According to some embodiments, at least two points disposed on one side of a wall 102, 104 to which at least two coupling elements 106, 108 are coupled can be disposed an equal distance apart as points disposed on another side of wall 102, 104 to which two other coupling elements 106, 108 are coupled.

According to embodiments, each coupling element 106A-D, 108A-D can be mechanically coupled to their respective walls 102, 104 via a tether, i.e., a tether may be coupled between a wall 102, 104 and a respective coupling element 106A-D, 108A-D. A tether can comprise a cord or strap comprising nylon webbing, polyester webbing, polypropylene webbing, or any combination thereof—to name a few examples. For example, in the illustrated embodiment of FIG. 1, each coupling element 106A-D is respectively coupled to wall 104 via respective tethers 110A-D which each comprise a strap. In embodiment, each coupling element can be configured to slide along the length of its respective tether when a force is applied to the coupling element.

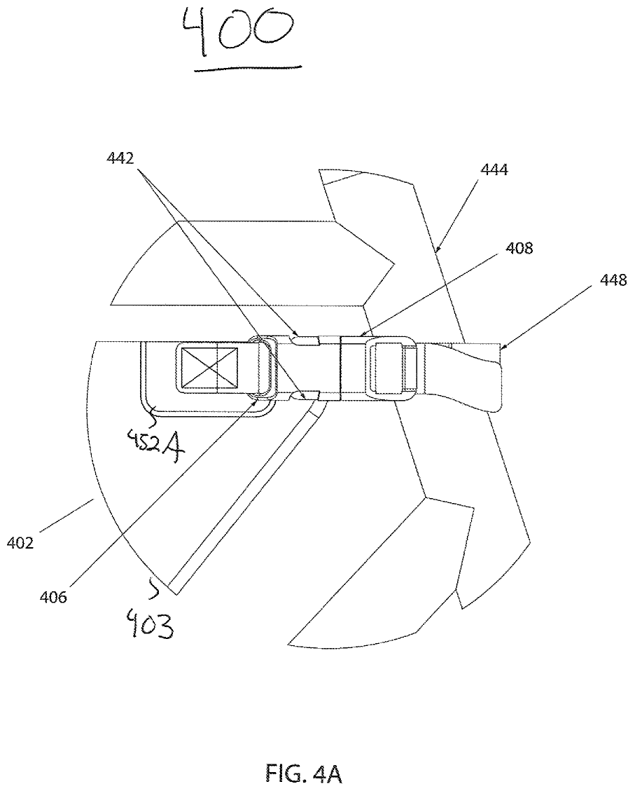

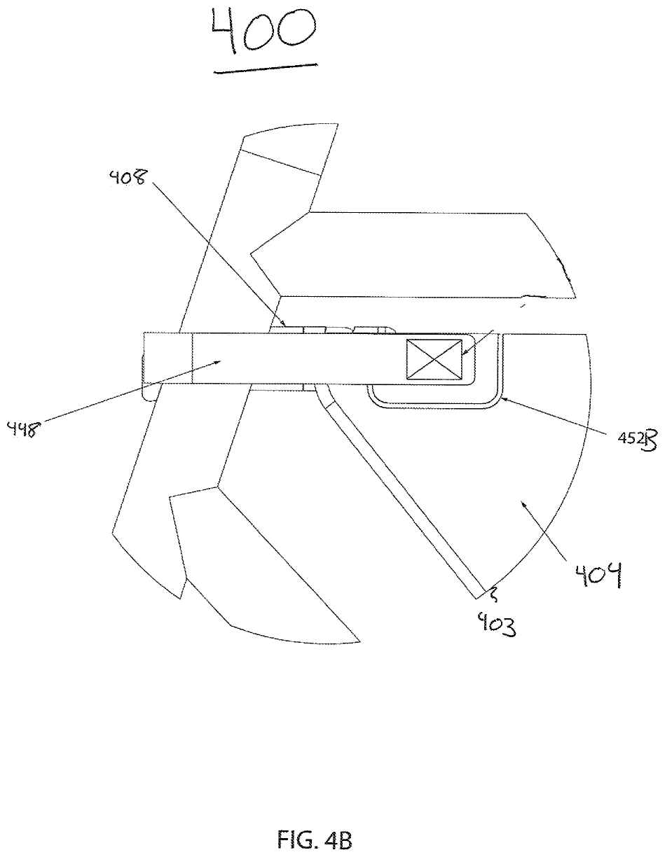

As discussed in further detail with reference to FIGS. 4A-B, coupling elements 108 coupled to a first wall 102 of article carrier 100 can be configured to couple, or mate, with coupling elements 106 coupled to a second wall 104 of article carrier 100.

In embodiments, each wall 102, 104 can comprise two or more anchor points 111. For example, in the illustrated embodiment of FIG. 1, wall 102 comprises anchor points 111 A-C. Each anchor point 111 can comprise a reinforced predetermined portion of a wall 102, 104. In embodiments, a predetermined portion of a wall 102, 104 may be reinforced by sewing a reinforcement layer onto at least a portion of the interior surface of a wall 102, 104.

The reinforcement layer may comprise a piece of material having a weight and a size, said size of the reinforcement layer being equal to the predetermined portion of wall 102, 104 to be reinforced. The material for the reinforcement layer can comprise rip-stop polyester, rip-stop nylon, polyester, vinyl, nylon, rubber, cotton, leather, polypropylene, or any combination thereof. In embodiments, the weight of the reinforcement layer can be equal to the weight of the material of the wall 102, 104 to be reinforced while in other embodiments, the weight of the reinforcement later can be greater than the weight of the material of the wall 102, 104 to be reinforced.

According to embodiments, a reinforcement layer can be coupled to the portion of the wall 102, 104 to be reinforced by stitching the reinforcement layer to the portion of wall 102, 104. The reinforcement layer may be stitched onto the interior, exterior, or both surfaces of the portion of wall 102, 104 with a general seam, felled seam, taped seam, lockstitch pattern seam or any combination thereof—to name a few. For example, the reinforcement layer can be coupled to a portion of a wall 102, 104 by stitching them together in a lockstitch pattern which allows for tensile forces exerted on the reinforced portion of wall 102, 104 to be distributed over the stitches of the lockstitch pattern.

In embodiments, the stitching between the reinforcement layer and the portion of wall 102, 104 can comprise polyester thread, nylon thread, cotton thread, or any combination thereof—to name a few.

In embodiments, each coupling element 106, 108 can be mechanically coupled to a respective wall 102, 104 at respective anchor points 111. For example, in the illustrated embodiment of FIG. 1, coupling element 108A is coupled to wall 102 at anchor point 111A, coupling element 108B is coupled to wall 102 at anchor point 111B, and coupling elements 108C and 108D are coupled to wall 102 at anchor point 111C.

By coupling each coupling element 106, 108 to a respective wall 102, 104 at an anchor point 111, tearing of article carrier 100 when removably coupled to a transportation device caused by heavy carry loads may be prevented.

In embodiments, article carrier 100 includes pouch 112. Pouch 112 may comprise a bag smaller in size than the bag 103 formed by walls 102, 104. Pouch 112 can comprise rip-stop polyester, rip-stop nylon, polyester, vinyl, nylon, rubber, cotton, leather, polypropylene, or any combination thereof, to name a few. In some embodiments, pouch 112 may comprise the same material as walls 102, 104 while in other embodiments a different material may be used.

In embodiments, pouch 112 may be mechanically coupled to the interior surface of a portion of at least one wall 102, 104. Pouch 112 can be coupled via stitching, fusing, adhesive, or any combination thereof. For example, pouch 112 can be coupled to an interior surface of a wall 102, 104 via polyester thread with a load-bearing stich such as a bar-tack stitch.

Pouch 112 is configured to store the bag 103 when article carrier 100 is not in use (i.e. not carrying a load, not coupled to a transportation device, or neither). In other words, pouch 112 is configured to store bag 103 when it is collapsed. To accomplish this, pouch 112 must be of sufficient size to store each wall 102, 104. In embodiments, pouch 112 can further be configured and be of sufficient size to store coupling elements 106, 108 as well as the bag formed by walls 102, 104.

In embodiments, pouch 112 may comprise a volume of less than 25 cubic inches when bag 103 and coupling elements 106, 108 are stored in pouch 112. Because pouch 112 has a volume of less than 25 cubic inches when everything is stored, article carrier 100 may be easily transported or stored when not in use. For example, article carrier 100 may fit in a pocket or a handbag when everything is stored in pouch 112.

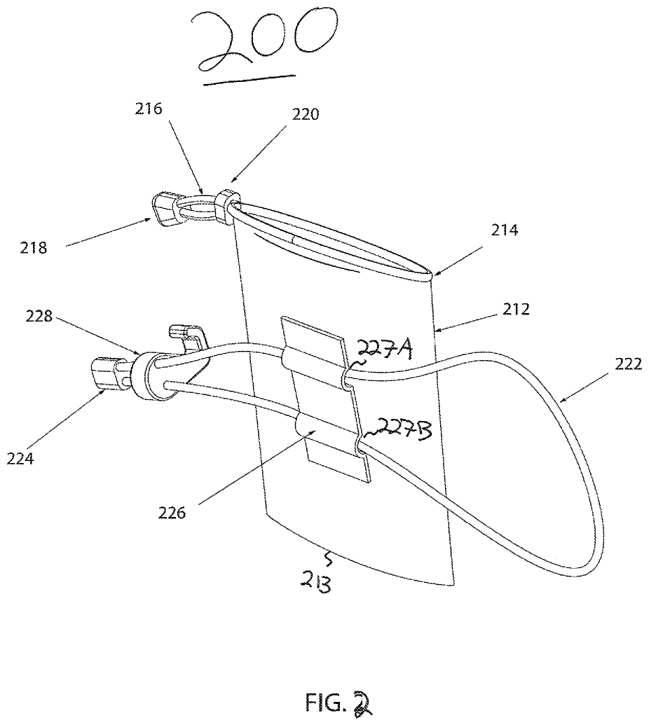

Referring now to FIG. 2, pouch 212, the similar or the same as pouch 112, includes bag 213, lip 214, cord 216 (comprising cap 218 and slide 220), coupling cord 222 (including cap 224 and slide 228) and panel 226. As discussed above with reference to FIG. 1, pouch 212 can be configured to store the bag 103 formed by walls 102, 104 and the coupling elements 106, 108 coupled to walls 102, 104.

Bag 213 can comprise rip-stop polyester, rip-stop nylon, polyester, vinyl, nylon, rubber, cotton, leather, polypropylene, or any combination thereof, to name a few and can have a sufficient size to store bag 213 and the coupling elements 106, 108 coupled to walls 102, 104 when article carrier 100 is not in use. In embodiments, bag 213 can include lip 214 that may comprise a hollow rim around the opening bag 213 configured to house, or store, at least a portion of cord 216. According to embodiments, lip 214 includes at least two openings that allow for first and second portions of cord 216 to be exposed.

Cord 216 can comprise a predetermined length of material with first and second opposite ends that may take a form such as flat, cylindrical, rounded, or any combination thereof, to name a few examples. The material of cord 216 can comprise nylon, rubber, polypropylene, polyester, cotton, or any combination thereof, to name a few. According to embodiments, the material of cord 216 comprises an elastic property.

According to embodiments, said first and second ends of cord 216 are housed within cap 218. Cap 218 may comprise acetal, nylon, molded plastic, or any combination thereof—to name a few—and may have a shape such as cylindrical, spherical, rectangular, etc. In other embodiments, said first and second ends of cord 216 may terminate in a knot.

In embodiments, cord 216 includes slide 220 configured to house at least a portion of the first exposed portion of cord 216 and at least a portion of the second exposed portion of cord 216. Slide 220 may comprise acetal, nylon, polycarbonate, polypropylene, molded plastic, or any combination thereof and may have a shape such as cylindrical, spherical, rectangular, etc. In embodiments, slide 220 can be configured to slide along the length of cord 216 is at least two directions.

In embodiments, lip 214 is configured to control the size of the opening of bag 212 when force is applied to cap 218, slide 220, or both. For example, a force may be applied to slide 220 in a direction away from cap 218. As the force is applied, slide 220 may slide along the first and second exposed portions of cord 216 in a direction away from cap 218. By sliding slide 220 away from cap 218, lip 214 is configured to narrow, or tighten, the opening of bag 213. Further, a force may be applied to slide 220 in a direction towards cap 218. As the force is applied, slide 220 may slide along the first and second exposed portions of cord 216 in a direction towards cap 218. By sliding slide 220 towards cap 218, lip 214 is configured to widen, or open, the opening of bag 213.

According to embodiments, lip 214 is configured to control the size of the opening of bag 212 when bag 103 formed by walls 102, 104 and the coupling elements 106, 108 coupled to walls 102, 104 are stored in pouch 212 and when they are not stored in pouch 212.

In embodiments, pouch 212 includes panel 226. Panel 226 can comprise nylon webbing, polyester webbing, polypropylene webbing, or any combination thereof, and can be disposed on the exterior of pouch 212 (for example as shown in the illustrated embodiment of FIG. 2). In embodiments, panel 226 can include two channels 227 A, B configured to house at least first and second portions of coupling cord 222, i.e., at least first and second portions of coupling cord 222 are configured to run respectively through channels 227 A, B.

In embodiments, coupling cord 222 is configured so at least exposed first and second portions of coupling cord 222 are disposed at a first side of panel 226 and a third exposed portion of coupling cord 222 is disposed at a second, opposite side of panel 226.

Coupling cord 222 can comprise a predetermined length of material with first and second opposite ends that may take a form such as flat, cylindrical, rounded, or any combination thereof, to name a few examples. The material for coupling cord 222 can comprise nylon, rubber, polypropylene, polyester, cotton or any combination thereof, to name a few. According to embodiments, the material of cord 216 comprises an elastic property.

In embodiments, said first and second ends of coupling cord 222 can be housed within cap 224. Cap 224 may comprise acetal, nylon, polycarbonate, polypropylene, molded plastic, or any combination thereof and may have a shape such as cylindrical, spherical, rectangular, etc. In other embodiments, said first and second ends of coupling cord 222 can terminate in a knot.

According to embodiments, coupling cord 222 includes hook 228 configured to house portions of the first and second exposed portions of coupling cord 222. Hook 228 can comprise acetal, nylon, polycarbonate, polypropylene, molded plastic or any combination thereof and can have a shape such as a rectangle, cylinder, hook, sphere or any combination thereof, to name a few examples. In embodiments, hook 228 is configured to slide towards cap 224 along the first and second exposed portions of coupling cord 222 when a force in a direction toward cap 224 is applied to hook 228 and configured to slide away from cap 224 along the first and second exposed portions when a force in a direction away from cap 224 is applied to hook 228.

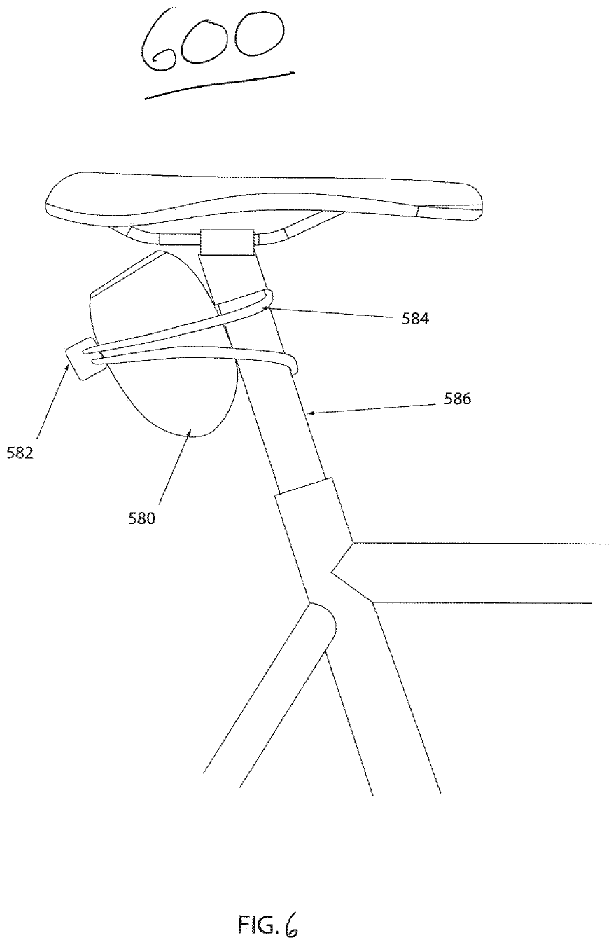

As discussed in further detail below with reference to FIG. 6, pouch 212 is configured to be removably coupled to a transportation device when bag 103 formed by walls 102, 104 and the coupling elements 106, 108 coupled to walls 102, 104 are stored within pouch 212. For example, a portion of the third exposed portion of coupling cord 222 may be tied around at least a portion of pouch 212 and at least a portion of a transportation device and anchored, or tied off at, hook 228. By tying a portion of the third exposed portion of coupling cord 222 around a portion of pouch 212 and a portion of a transportation device, a force is applied to pouch 212 and the transportation device, coupling the pouch 212 to the transportation device.

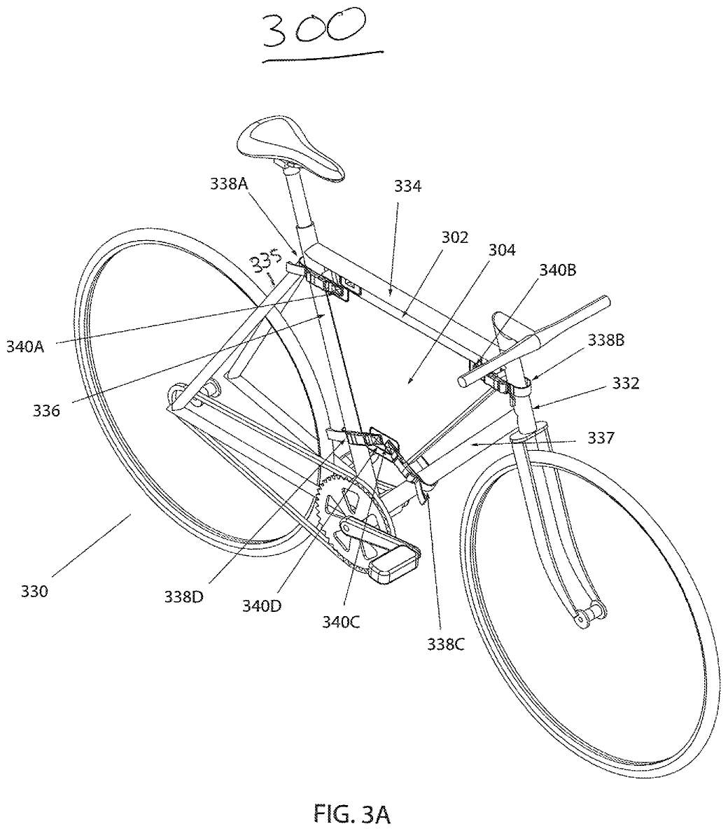

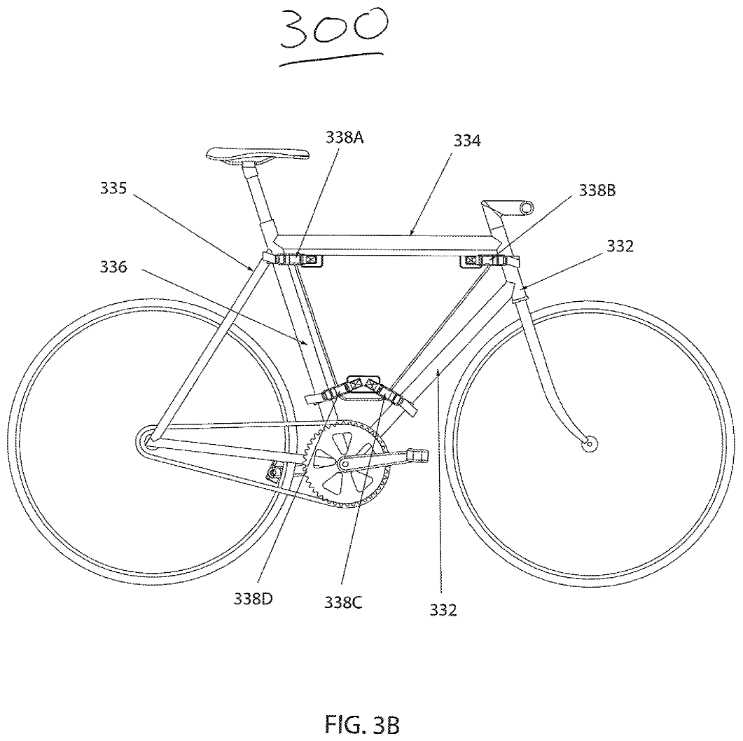

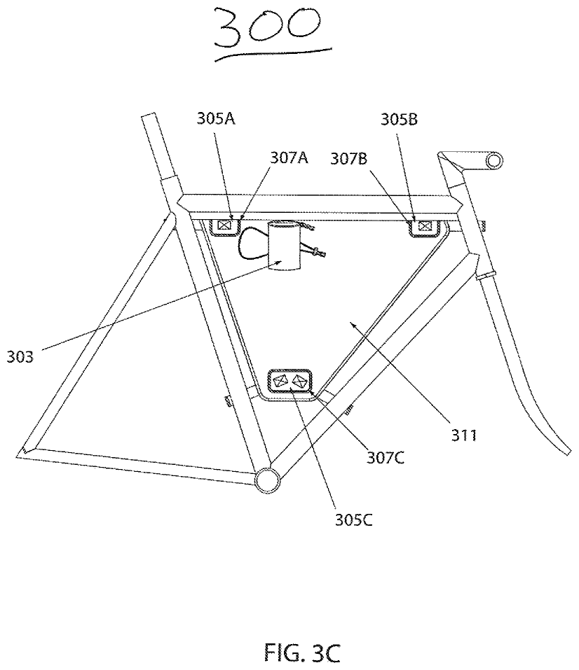

Referring now to FIGS. 3A-C, article carrier 300, the same or similar as article carrier 100, can be configured to be removably coupled to a transportation device (shown in FIG. 3A as bicycle 330). In embodiments, article carrier 300 can be configured to be removably coupled to transportation devices such as bicycles, motorcycles, scooters, or any combination thereof—to name a few examples. While the illustrated embodiments of FIGS. 3A-C depict one arrangement for removably coupling article carrier 300 to a transportation device, in other embodiments, other arrangements may be used.

In embodiments, article carrier 300 includes first and second opposite walls 302, 304. Wall 302 is coupled to two or more coupling elements (represented in FIG. 3A as coupling elements 338A-D) and wall 304 is coupled to two or more different coupling elements (represented in FIG. 3A as coupling elements 340A-D).

In embodiments, at least two coupling elements 338, 340 can be coupled to a wall 302, 304 at points disposed around two or more sides of the wall 302, 304. In some embodiments, the coupling elements, 306, 308 can be coupled to a wall 302, 304 at points disposed around all but one side of the wall 302, 304 while in other embodiments the coupling elements 306, 308 can be coupled to points disposed around a fewer number of sides.

As discussed above with reference to FIG. 1, each coupling element 338, 340 may include a tether coupled between the coupling element 338, 340 and its respective wall 302, 304.

As discussed below with reference to FIGS. 4A and B, coupling elements 338A-D coupled to wall 302 are configured to be removably coupled, or mate, with the coupling elements 340 A-D coupled to wall 304. In embodiments, coupling elements 338A-D can comprise a first gender of coupling elements and coupling elements 340A-D can comprise a second, opposite gender of coupling elements configured to mate with the first gender of coupling elements.

In embodiments, article carrier 300 can be configured to be removably coupled to bicycle 330 that includes a frame with frame tubes (hereinafter “tubes”) 332. 334, 335, 336, and 338. Article carrier 300 can be removably coupled to two or more tubes of bicycle 330 via coupling elements 338 and coupling elements 340 when each of coupling elements 338 is coupled to a respective coupling element 340.

According to embodiments, each coupling element can be coupled to a respective coupling element disposed substantially across from said coupling element 338 and coupled to the opposite wall. For example, in the illustrated embodiments of FIGS. 3A and B, coupling element 338A (coupled to wall 302) is coupled to coupling element 340A (coupled to wall 304) disposed substantially across from coupling element 338 A.

When each coupling element 338 is coupled to a respective coupling element 340, each coupling element 338 and respective coupling element 340 are configured so that at least a portion of coupling element 338, respective coupling element 340, or both are wrapped around a tube of bicycle 330. For example, in the illustrated embodiment of FIG. 3A, coupling element 338C is coupled to coupling element 340C so that at least a portion of coupling element 338C is wrapped around tube 337.

In embodiments, when at least a portion of a coupling element 338, respective coupling element 340, or both, is wrapped around one or more tubes of bicycle 330, a force is applied to said tubes and the bag formed by walls 302, 304 so that at least a portion of the bag is coupled to the tubes. According to embodiments, the force applied to the tubes and the bag is of a sufficient magnitude as to keep at least a portion of the bag suspended from said tubes. In embodiments, the force applied to the tubes may also be of a sufficient magnitude so that the bag does not slide along said tubes when bicycle 330 is in motion, article carrier 300 is carrying a load, or both.

According to embodiments, when article carrier 300 is coupled to two or more tubes of bicycle 330 via coupling elements 338, 340, the bag formed by walls 302, 304 is suspended and disposed in the space between the tubes of bicycle 330. For example, in the illustrated embodiment of FIG. 3B, article carrier 300 can be coupled to tube 335, 336 via coupling elements 338A, 340A and coupling elements 338D, 340D, tube 332 via coupling elements 338C, 340C, and tube 331 via coupling elements 338B, 340B. As can be seen from the illustrated embodiment of FIG. 3B, when article carrier 300 is coupled to tubes 331, 332, and 336, the bag formed by walls 302, 304 is suspended and disposed in the space between tubes 331, 332, and 336.

In embodiments, the bag formed by walls 302, 304 may have a shape that depends on the force applied to the bag by the portions of coupling elements 338, 340 wrapped around the tubes of bicycle 330. For example, the width or height of the bag may depend on the forces applied to the bag by the portions of coupling elements 338, 340 wrapped around the tubes of bicycle 330. According to embodiments, the bag formed by walls 302, 304 may have a shape that also depends on the distance between the tubes of bicycle 330. For example, the width or height of the bag may decrease as the distance between the tubes of bicycle 330 decreases.

According to embodiments, article carrier 300 may be configured so that when article carrier 300 is coupled to two or more tubes of bicycle 330, the bag formed by walls 302, 304 may have a shape substantially similar to the shape of the space between the two or more tubes. For example, as can be seen in the illustrative embodiment of FIG. 3B, the bag formed by walls 302, 304 has a substantially similar shape as the shape of the space between tubes 331, 332, and 336.

Referring now to FIG. 3C, a view of the interior surface 311 of wall 302 is shown. Each wall 302, 304 includes one or more anchor points 305 that each comprise a reinforced predetermined portion of a wall 302, 304. As discussed above with reference to FIG. 1, a predetermined portion of a wall 302, 304 may be reinforced by sewing a reinforcement layer onto at least a portion of the interior surface of a wall 302, 304.

In embodiments, each coupling element 338, 340 is coupled to a respective wall 302, 304 at a respective anchor point 305. By coupling each coupling element 338, 340 to a respective wall 302, 304 at an anchor point 305, tearing of article carrier 300 may be prevented when article carrier 300 is coupled to two or more tubes of bicycle 330 and a heavy load is carried by article carrier 300, bicycle 330 is in motion, or both.

According to embodiments, article carrier 300 can include pouch 303, similar or the same as pouch 112 as discussed above with reference to FIG. 1. In embodiments, pouch 303 is configured to store at least the bag formed by walls 302, 304, coupling elements 338, and coupling elements 340 when article carrier 300 is not in use (i.e. not coupled to the tubes o bicycle 330). Pouch 303 can be coupled to the interior surface 311 of wall 302 via stitching, fusing, adhesive, or any combination thereof.

Referring now to FIGS. 4A and B, an example embodiment of coupling elements 406, 408 is presented for removably coupling article carrier 400 to a transportation device. Article carrier 400, the same or similar as article carrier 100 (FIG. 1), includes a first and second opposite walls 402, 404 coupled together to form a bag 403.

In embodiments, coupling elements 406 are coupled to an exterior surface of wall 402 and coupling elements 408 are coupled to an exterior surface of wall 404.

In embodiments, at least two coupling elements 406, 408 can be coupled to a wall 402, 404 at points disposed around two or more sides of the wall 402, 404 so that bag 403 can be suspended from a transportation device. In some embodiments, the coupling elements, 406, 408 can be coupled to a wall 402, 404 at points disposed around all but one side of the wall 402, 404 while in other embodiments the coupling elements 406, 408 can be coupled to points disposed around a fewer number of sides. According to some embodiments, at least two points disposed on one side of a wall 402, 404 to which at least two coupling elements 406, 408 are coupled can be disposed an equal distance apart as points disposed on another side of wall 402, 404 to which two other coupling elements 406, 408 are coupled.

In embodiments, each coupling element 406 is configured to removably couple to, or mate with, at least one coupling element 408. Each of coupling elements 406, 408 can comprise buckles, hooks, Velcro, latches, or any combination thereof—to name a few examples. In embodiments, coupling elements 406 may each comprise a first gender of connector and coupling elements 408 may comprise a second gender of the same connector while in other embodiments each of coupling elements 406, 408 may comprise a variety of genders.

For example, in the illustrated embodiments of FIG. 4A coupling element 406 comprises a female half of a buckle assembly and coupling element 408 comprises the male half of a buckle assembly. Coupling element 408 includes two tabs 442 that are configured to prevent coupling elements 406, 408 from decoupling once they are coupled, or mated, together. Coupling element 406 may be uncoupled from coupling element 408 by applying force on both tabs 442 in a direction towards the buckle assembly.

In embodiments, each coupling element 406, 408 can comprise a tether coupled between said coupling element 406, 408 and a respective wall of bag 403. For example, in the illustrated embodiments of FIGS. 4A and B, coupling element 408 is shown to include tether 448 configured to couple coupling element 408 to wall 404 of bag 403.

In some embodiments, each coupling element 406, 408 can be configured to slide along its respective tether when a force is applied to said coupling element. According to embodiments, when a force is applied to a coupling element 406, 408 in a direction towards its respective wall to which it is coupled, said coupling element 406, 408 can be configured to slide along its respective tether in a direction towards its respective wall. In embodiments, when a force is applied to a coupling element 406, 408 in a direction away its respective wall to which it is coupled, said coupling element 406, 408 can be configured to slide along its respective tether in a direction away from its respective wall.

As discussed above with reference to FIGS. 3A-C, each coupling element 406, 408 can be coupled to a wall 402, 404 by an anchor point 452. For example, the illustrated embodiments of FIGS. 4A and 4B, coupling element 406 is coupled to wall 404 by anchor 452B. In embodiments, the tether 448 of a coupling element 406, 408 may be coupled to an anchor point 452.

In embodiments, each coupling element 406 and a respective coupling element 408 disposed substantially across from said coupling element 406 and coupled to the opposite wall (i.e. coupled to a point disposed in a substantially similar location on the opposite wall) form a coupling pair. The coupling pair is configured to removably couple at least a portion of bag 403 to a transportation device.

According to embodiments, when the coupling elements 406, 408 of a coupling pair are coupled together, at least a portion of coupling element 406, a portion of coupling element 408, or both of the coupling pair may be configured to wrap around a portion of a transportation device. For example, in the illustrated embodiment of FIG. 4A, a coupling pair comprising coupling element 406 and coupling element 408 is presented. When coupling elements 406, 408 of the coupling pair are coupled, a portion of coupling element 408 (presented in FIGS. 4A and B as tether 448) is configured to wrap around tube 444 of a bicycle.

In embodiments, when at least a portion of coupling element 406, a portion of coupling element 408, or both of a coupling pair is wrapped around a portion of a transportation device, a force is applied to bag 403 and the transportation device so that at least a portion of bag 403 is coupled to the transportation device. According to embodiments, the force applied to the transportation device and bag 403 is of a sufficient magnitude as to keep at least a portion of bag 403 suspended from the transportation device. In embodiments, the force applied to the transportation device and bag 403 may also be of a sufficient magnitude so that bag 403 does not slide along the transportation device when the device is in motion.

In embodiments, the magnitude of the force applied to bag 403 and the transportation device by at least a portion of coupling element 406, a portion of coupling element 408, or both of a coupling pair may depend on the position of said coupling elements 406, 408 along their respective tethers. In other words, as a coupling element 406, 408 slides along its respective tether, the force applied to bag 403 and the transportation device may change.

According to embodiments, the magnitude of the force applied to bag 403 and the transportation device by at least a portion of coupling element 406, a portion of coupling element 408, or both of a coupling pair may increase as a coupling element 406, 408 of the coupling pair slides towards its respective wall of bag 403 and may decrease as a coupling element 406, 408 slides away from its respective wall of bag 403.

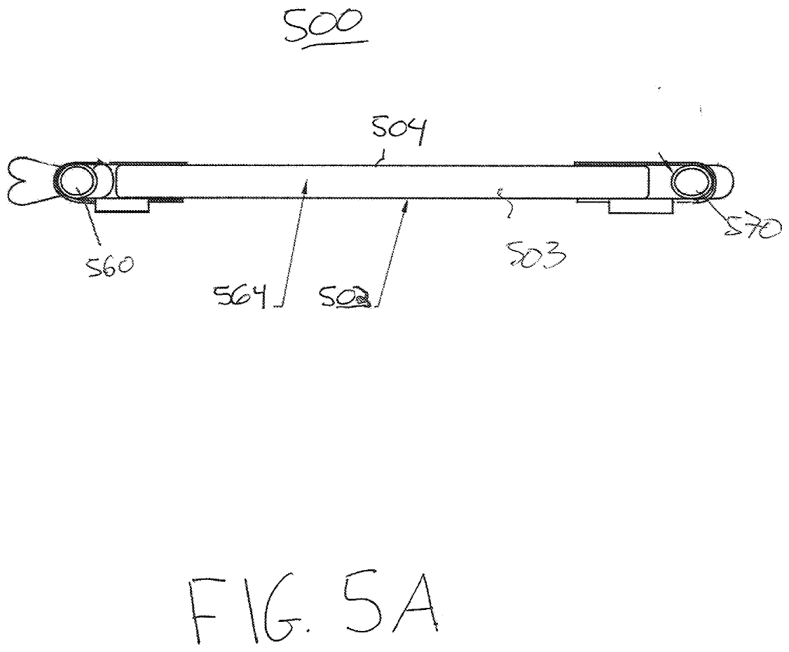

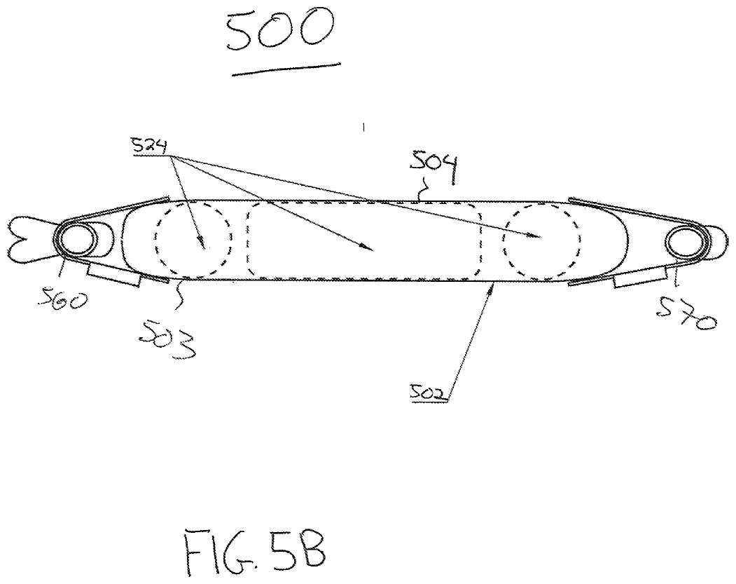

Referring now to FIGS. 5A and 5B, article carrier 500 is configured to removably couple to tubes 560, 570 of a transportation device and includes walls 502, 504 formed into bag 503, the same or similar as bag 103 (FIG. 1). Bag 503 includes an opening 564 of sufficient size as to allow articles 524 to be inserted into bag 503. According to some embodiments, opening 564 can comprise a zipper, rolled closure system, or other system for controlling the size of opening 564. In embodiments, said zipper, rolled closure system, or other system for controlling the size of opening 564 may alter the size of opening 564 so that opening 564 is water-resistant or water-proof. In other words, said zipper, rolled closure system, or other system for controlling the size of opening 564 may close opening 564 so that it is water-resistant or water proof.

In embodiments, bag 503 can be configured to allow walls 502, 504 to adjust their shape to accommodate the size and shape of articles 564. For example, when an article 564 is inserted into bag 503, bag 503 can be configured so that the shape of walls 502, 504 are altered in one or more directions to accommodate the size and shape of said article 564.

In embodiments, bag 503 can be configured to allow walls 502, 504 to adjust their shape to accommodate the size and shape of articles 564 by each wall comprising a flexible material configured to accommodate the size and shape of article 564 such as rip-stop nylon.

Referring now to FIG. 6, an example embodiment of pouch 680, similar or the same as pouch 212 (FIG. 2), is coupled to seat tube 686 of a transportation device (shown in FIG. 6 as a bicycle). Pouch 680 includes coupling cord 684, similar or the same as coupling cord 222 (FIG. 2), that includes hook 682, similar as the same as hook 228 (FIG. 2).

Coupling cord 684 can comprise a predetermined length of material with first and second opposite ends that may take a form such as flat, cylindrical, rounded, or any combination thereof, to name a few examples. The material of coupling cord 684 can comprise nylon, rubber, polypropylene, polyester, cotton, or any combination thereof, to name a few. According to embodiments, the material of coupling cord 684 comprises an elastic property.

According to embodiments, said first and second ends of coupling cord 684 can be housed within a cap (not shown) similar or the same as cap 218 (FIG. 2). In other embodiments, said first and second ends of coupling cord 684 may terminate in a knot.

In embodiments, pouch 680 includes a panel (not shown) the same or similar as panel 226 (FIG. 2) disposed on an exterior of pouch 680. In embodiments, the panel can include two channels configured to house at least first and second portions of coupling cord 684. In embodiments, coupling cord 684 is configured so at least exposed first and second portions of coupling cord 684 are disposed at a first side of the panel and a third exposed portion of coupling cord 684 is disposed at a second, opposite side of the panel. In embodiments, the third exposed portion of coupling cord 684 can comprise a loop.

According to embodiments, coupling cord 684 includes hook 682 configured to house portions of the first and second exposed portions of coupling cord 684. Hook 682 can comprise acetal, nylon, polycarbonate, polypropylene, molded plastic or any combination thereof and can have a shape such as a rectangle, cylinder, hook, sphere or any combination thereof, to name a few examples. In embodiments, hook 682 is configured to slide towards the ends of the first and second exposed portions of coupling cord 684 when a force in a direction toward the ends of the exposed portions is applied to hook 682 and configured to slide away from the ends of the first and second exposed portions when a force in a direction away from the first and second ends of the exposed portions is applied to hook 682.

In embodiments, at least a portion of the third exposed portion of coupling cord 684 is configured to removably couple with hook 682. For example, the third exposed portion of coupling cord 684 can be tied around hook 682.

According to embodiments, a portion of the third exposed portion of coupling cord 684 can be configured to wrap around a portion of a transportation device (shown as seat tube 686 in FIG. 6) when the third exposed portion of coupling cord 684 is coupled to hook 682. For example, in the illustrated embodiment of FIG. 6, the third exposed portion of coupling cord 684 is configured to wrap around seat tube 686 when the third exposed portion is coupled to hook 682.

In embodiments, when the third exposed portion of coupling cord 684 is wrapped around a portion of the transportation device, a force is applied to pouch 680 and the portion of the transportation device so that pouch 680 is coupled to the portion of the transportation device. According to embodiments, the force applied to transportation device and pouch 680 is of a sufficient magnitude as to keep pouch 680 coupled to the transportation device and may also be of a sufficient magnitude so that pouch 680 does not slide along the transportation device when the transportation device is stationary or in motion.

In embodiments, the magnitude of the force applied to pouch 680 and the transportation device may depend on the location of hook 682 on coupling cord 684 (i.e. the magnitude of the force may change as hook 682 slides along the first and second exposed portions of coupling cord 684). For example, the magnitude of the force applied to pouch 680 and the transportation device may increase as hook 682 slides away from the ends of the first and second exposed portions of coupling cord 684 and may decrease when hook 682 slides towards ends of the first and second exposed portions of coupling cord 684.

According to embodiments, when the third exposed portion of coupling cord 684 is uncoupled (e.g. untied) from hook 682, the force is no longer applied to pouch 680 and the transportation device, thus uncoupling pouch 680 from the transportation device.

Having described exemplary embodiments, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. An article carrier for bicycles, the article carrier comprising:
a bag including first and said opposing walls;
at least two coupling elements mechanically coupled to the first wall;
at least two coupling elements mechanically coupled to said second wall, each of said coupling elements mechanically coupled to said second wall configured to removably couple to at least one coupling element mechanically coupled to the first wall; and
a pouch coupled to the bag, said pouch configured to store at least the bag, the at least two coupling elements mechanically coupled to said first wall, and the at least two coupling elements mechanically coupled to said second wall.

2. The article carrier of claim 2, wherein the at least two coupling elements mechanically coupled to the first wall and the at least two coupling elements mechanically coupled to the second wall are configured to couple the bag to two or more portions of a transportation device when each of the coupling elements mechanically coupled to the first wall are removably coupled to respective coupling elements mechanically coupled to the second wall.

3. The article carrier of claim 2, wherein a force is applied to the bag when the bag is coupled to the two or more portions of the transportation device, said bag having a shape based upon the applied force.

4. The article carrier of claim 3, wherein said shape is further based upon a distance between the two or more portions of the transportation device.

5. The article carrier of claim 1, wherein the first wall of the bag comprises an anchor point, said anchor point mechanically coupled to at least one coupling element mechanically coupled to the first wall.

6. The article carrier of claim 1, wherein the bag further comprises a zipper configured to adjust a size of an opening of the bag.

7. The article carrier of claim 1, wherein the pouch is configured to store the bag, the at least two coupling elements mechanically coupled to the first wall, and the at least two coupling elements mechanically coupled to the second wall.

8. An article carrier configured to be removably coupled a bicycle, the article carrier comprising:
a bag;
at least four coupling elements, at least two of said coupling elements having a first gender and at least another two of said coupling elements having a second gender, said at least two coupling elements having the first gender configured to removably couple with the at least two coupling elements having the second gender; and
a pouch configured to store at least the bag, the coupling elements of the first gender, and the coupling elements of the second gender;
wherein the pouch comprises a coupling cord, said coupling cord configured to couple the pouch to a bicycle when the bag, the coupling elements of the first gender, and the coupling elements of the second gender, are stored in the pouch.

9. The article carrier of claim 8, wherein the pouch further comprises a cord configured to adjust an opening of the pouch.

10. The article carrier of claim 8, wherein the coupling cord is configured to apply a force to the pouch and the bicycle when the pouch is coupled to the bicycle.

11. The article carrier of claim 10, wherein the pouch further comprises a hook configured to adjust the force applied to the pouch and the bicycle when the pouch is coupled to the bicycle.

12. The article carrier of claim 10, wherein the pouch has a volume less than 25 cubic inches.

13. The article carrier of claim 10, wherein the bag comprises an anchor point coupled to one or more coupling elements of the first gender.

14. The article carrier of claim 10, wherein the at least four coupling elements are configured to removably couple the article carrier to the bicycle when the at least two coupling elements of the first gender are removably coupled with the at least two coupling elements of the second gender.

15. An article carrier for a transportation device, the article carrier comprising:
a bag including first and second opposing walls, each of said walls comprising an anchor point;
a first coupling element mechanically coupled to the anchor point of the first wall;
a second coupling element mechanically coupled to the anchor point of said second wall, said second coupling element configured to removably couple to the first coupling element; and
a pouch coupled to the bag, said pouch configured to store at least the bag, the first coupling element, and the second coupling element.

16. The article carrier of claim 16, wherein the first and second coupling elements are configured to removably couple the article carrier to the transportation device when the first and second coupling elements are coupled together.

17. The article carrier of claim 15, wherein the anchor point of the first wall comprises a material coupled to at least a portion of the first wall.

18. The article carrier of claim 17, wherein the material of the anchor point comprises a same material as the first wall.

19. The article carrier of claim 17, wherein the anchor point comprises a material having a thickness greater than a material of the first wall.

20. The article carrier of claim 17, wherein the anchor point is coupled to the at least a portion of the first wall with a lockstitch pattern.
